(19) United States
(12) Patent Application Publication
(10) Pub. No.: US 2016/0244113 A1
(43) Pub. Date: Aug. 25, 2016

(54) BICYCLE SEAT ASSEMBLY

(71) Applicant: Mu-Rong Li, Taichung City (TW)

(72) Inventor: Mu-Rong Li, Taichung City (TW)

(21) Appl. No.: 14/630,647

(22) Filed: Feb. 25, 2015

(51) Int. Cl. B62J 1/02; B62J 1/18

(52) U.S. Cl. CPC B62J 1/02; B62J 1/18

(57) ABSTRACT

A bicycle seat assembly includes a seat with a rail part connected to the underside thereof, the rail part includes a front, rear, left and right supports. There are the rear, left and right supports are located at the rear section of the seat so as to provide proper support to the user. The pressure to the user's bottom is reduced and the user does not need to sit toward the front end of the seat.

### BACKGROUND OF THE INVENTION

1. Fields of the Invention

The present invention relates to a bicycle seat assembly, and more particularly, to a bicycle seat assembly having three support portions located at the rear section of the seat so as to support the user's weight properly.

2. Descriptions of Related Art

The conventional bicycle seat assembly is disclosed in FIGS. 1 and 2, and comprises a seat 1 and a rail part 2, wherein the seat 1 has a narrow front end and a wider rear end, and the rail part 2 is a metal part which has a bent portion at the front end thereof and two distal ends at the rear end thereof. Two bars 3 are formed between the bent portion and the two distal ends of the rail part 2. The two distal ends are located on two sides of the axis of the seat 1, and the bent portion is engaged with a first reception member 4 at the front end of the seat, and the two distal ends are received in two reception members 5 at the rear end of the seat 1. The bars 3 are bent downward when viewed from one side of the seat 1.

However, the user's bottom mostly sits at the rear end of the seat 1, and the two distal ends of the rail part 2 do not have properly flexibility so that a pressure will be applied to the user's bottom. The user tents to sit toward the front end of the seat to avoid the pressure applied to the user's bottom. This causes the weight applied to the front portion of the user's bottom and the user feel uncomfortable.

The present invention intends to provide a bicycle seat to eliminate the shortcomings mentioned above.

### SUMMARY OF THE INVENTION

The present invention relates to a bicycle seat assembly and comprises a seat having a front support, rear support, a left support, a right support respectively located at the underside thereof. The front support is located at the front end and along the axis of the seat, and the rear support is located at the rear end and along the axis of the seat. The left support and the right support are respectively located at the rear end of the seat, and the axis of the seat is located between the left support and the right support.

A rail part has a front part, a fork portion connected to the front part, an extension portion connected to the fork portion, a rear merging portion connected to the extension portion, and a rear part connected to the rear merging portion. The front part, the fork portion, the extension portion, the rear merging portion and the rear part are all located along the axis of the seat. The rail part has a left support bar and a right support bar respectively extending toward left and right relative to the axis from the abutment portion of the extension portion and the rear merging portion.

The front part is glued to the front support, and the rear part is glued to the rear support. The distal end of the left support bar is mounted with a resilient member, and both are inserted in the left support. The distal end of the right support bar is mounted with another resilient member, and both are inserted in the right support.

The primary object of the present invention is to provide a bicycle seat assembly wherein the seat has three supports located at the rear section thereof so as to support the weight of the user properly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a bottom view of the conventional seat assembly;

FIG. 2 is a side view of the conventional seat assembly;

FIG. 3 is a top perspective view to show the seat assembly of the present invention;

FIG. 4 is a bottom perspective view to show the seat assembly of the present invention;

FIG. 5 is a bottom view of the seat assembly of the present invention;

FIG. 6 is an exploded view of the seat assembly of the present invention;

FIG. 7 is another exploded view of the seat assembly of the present invention;

FIG. 8 is a side view of the seat assembly of the present invention;

FIG. 9 is a rear view of the seat assembly of the present invention;

FIG. 10 is a front view of the seat assembly of the present invention;

FIG. 11 is a cross sectional view, taken along line XI-XI in FIG. 3, and

FIG. 12 is a cross sectional view, taken along line XII-XII in FIG. 3.

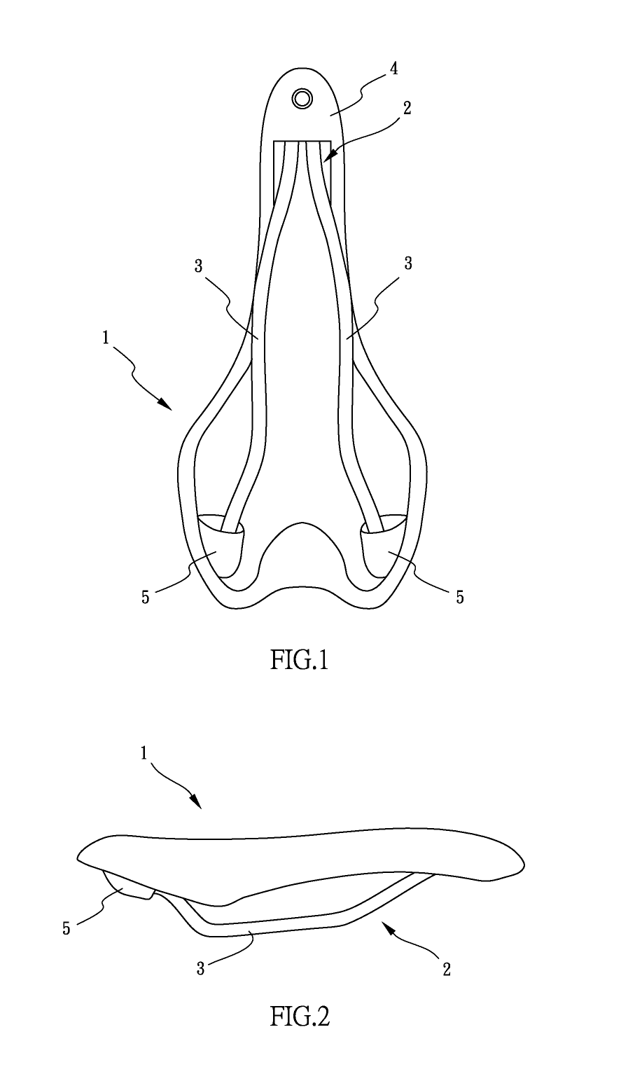

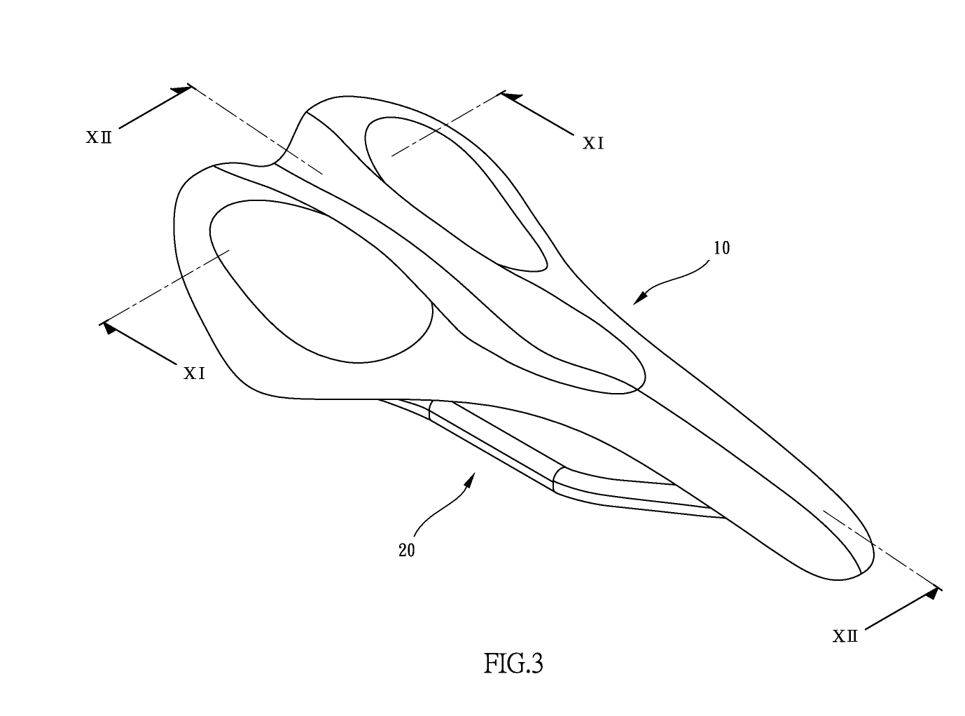

### DETAILED DESCRIPTION OF THE PREFERRED EMBODIMENT

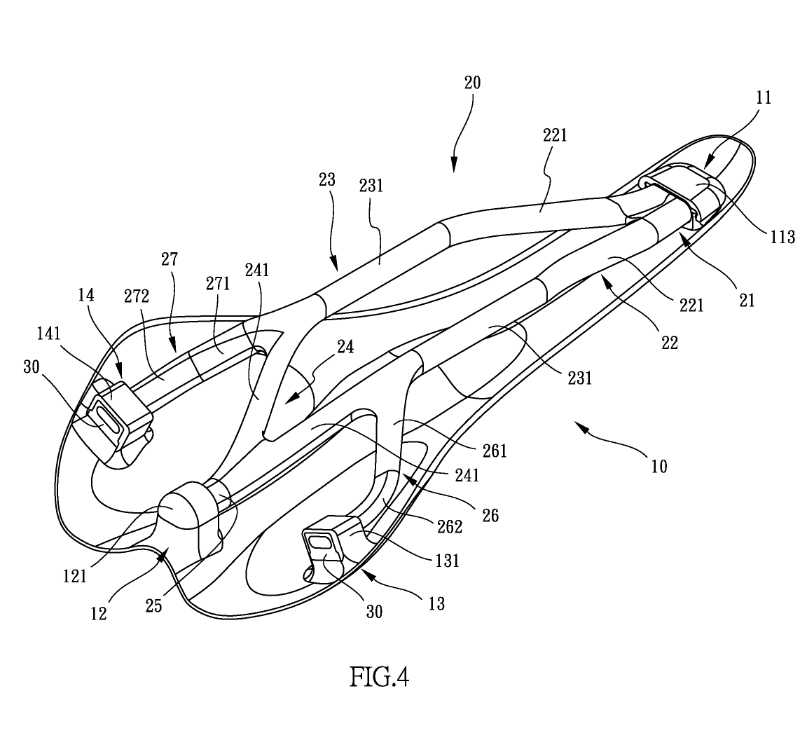

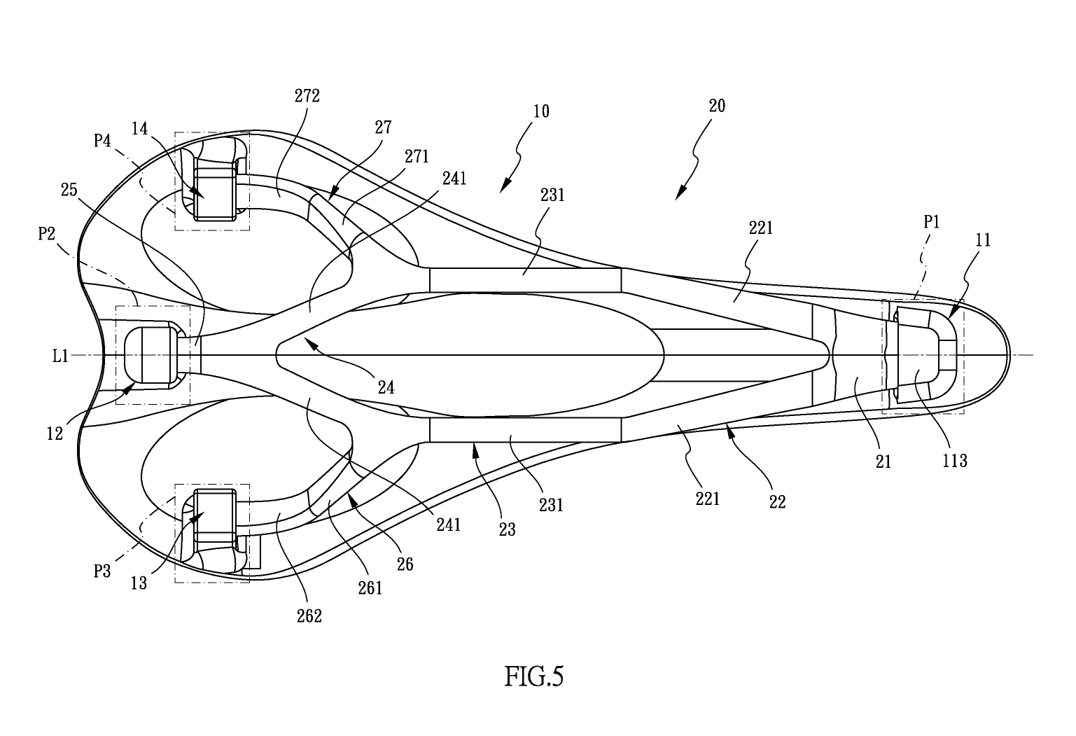

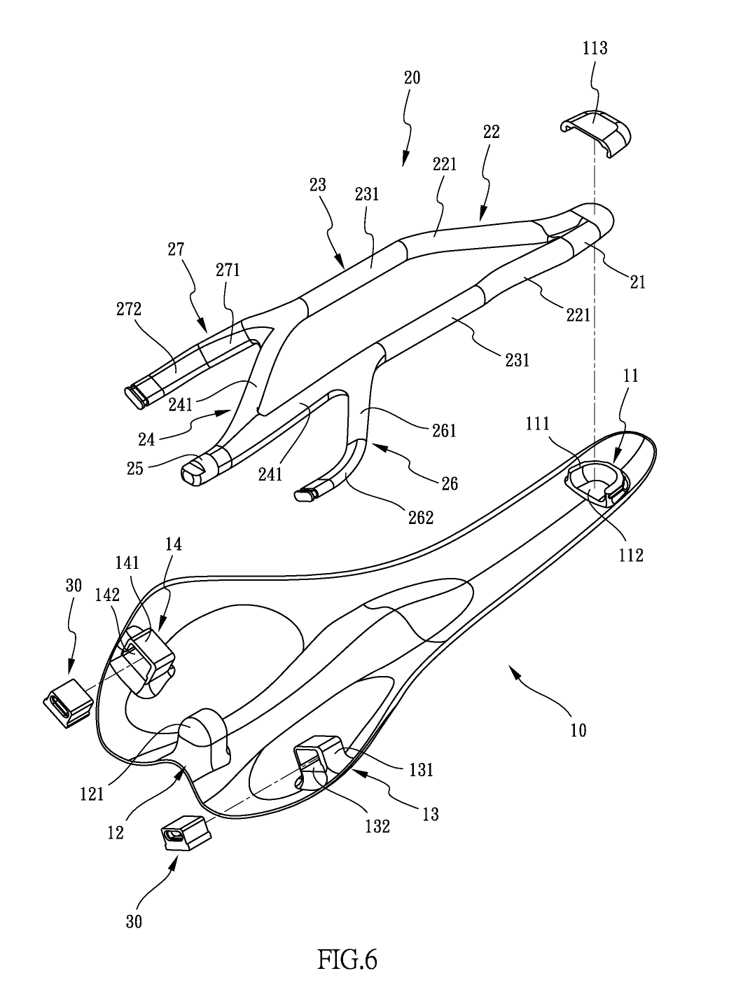

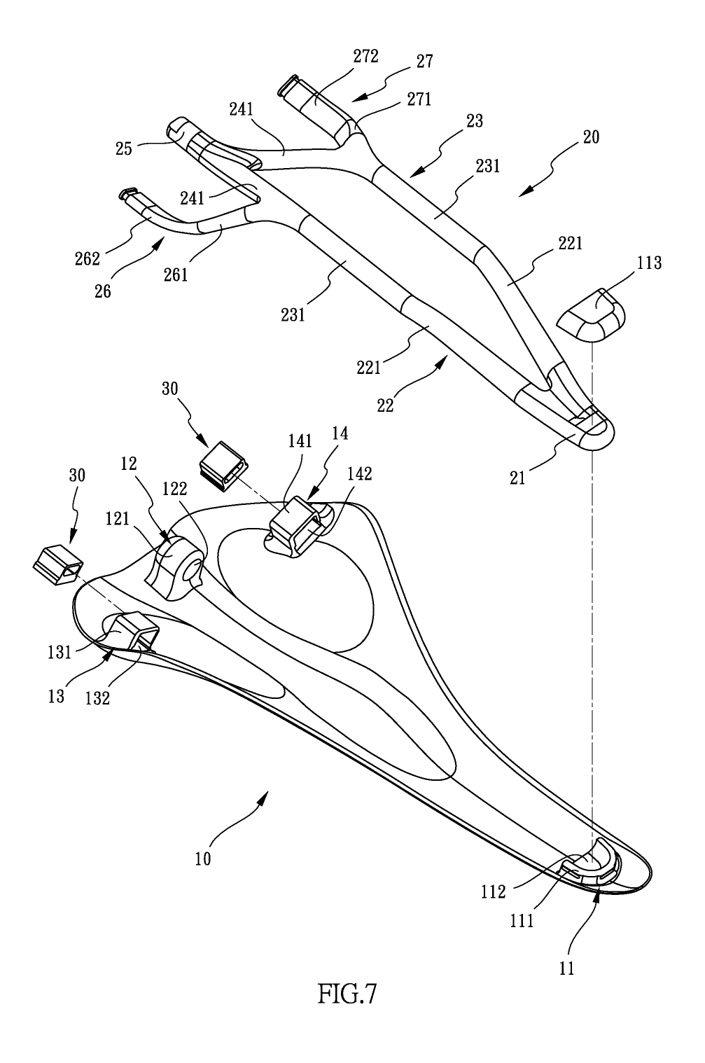

Referring to FIGS. 3 to 7, the bicycle seat assembly of the present invention comprises a seat 10 having a front support 11, rear support 12, a left support 13, a right support 14 respectively located at the underside thereof The front support 11 is located at the front end and along the axis L1 of the seat 10, and the rear support 12 is located at the rear end and along the axis L1 of the seat 10. The left support 13 and the right support 14 are respectively located at the rear end of the seat 10, and the axis L1 of the seat 10 is located between the left support 13 and the right support 14.

A rail part 20 is a one-piece part and comprises a front part 21, a fork portion 22 connected to the front part 21, an extension portion 23 connected to the fork portion 22, a rear merging portion 24 connected to the extension portion 23, and a rear part 25 connected to the rear merging portion 24. The front part 21, the fork portion 22, the extension portion 23, the rear merging portion 24 and the rear part 25 are all located along the axis 11 of the seat 10 from the front end to the rear end of the seat 10 in sequence. The rail part 20 has a left support bar 26 and a right support bar 27 respectively extending toward left and right relative to the axis L1 from the abutment portion of the extension portion 23 and the rear merging portion 24.

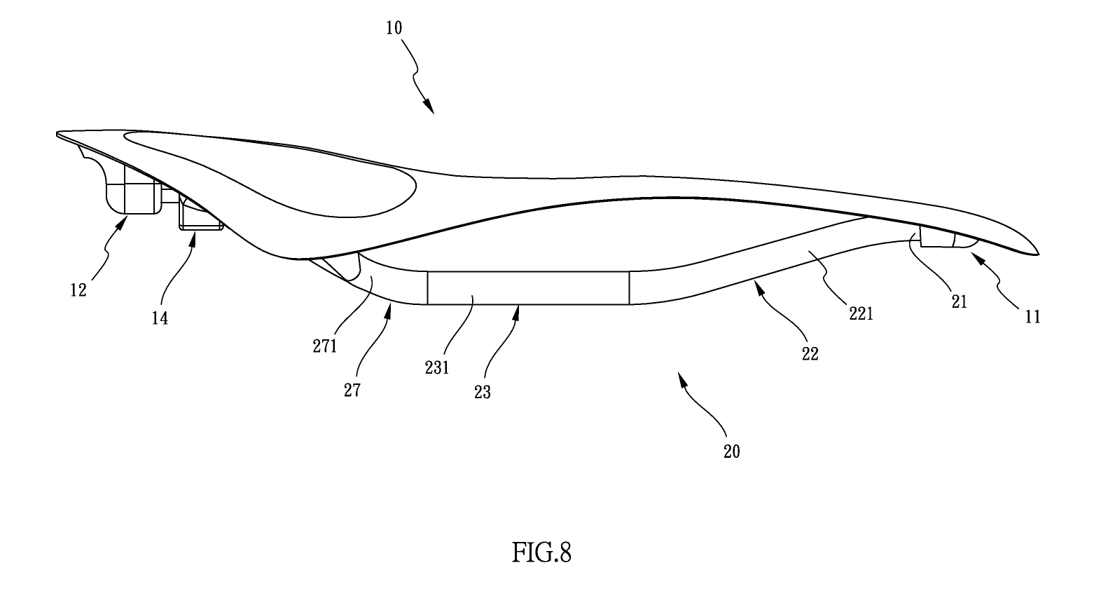

Each of the left and right support bars 26, 27 comprises a front section 261/271 and a rear section 262/272, wherein the front section 261/271 of each of the left and right support bars 26, 27 extends away from the axis L1 and from the abutment portion of the extension portion 23 and the rear merging portion 24, and the rear section 262/272 of each of the left and right support bars 26, 27 is parallel to the axis L1 and located close to the left support 13 and right support 14. The fork portion 22 has two split rails 221 which split from the front part 21 and are not parallel to the axis L1. The extension portion 23 has two parallel bars 231 which are parallel to the axis L1 and respectively extend from the two split rails 221. The rear merging portion 24 has two merging bars 241 which respectively extend from the two parallel bars 231. The two respective distal ends of the two merging bars 241 are merged into the rear part 25. As shown in FIG. 8, the two split rails 221, the two parallel bars 231 and the two merging bars 241 form a bow-shaped arrangement.

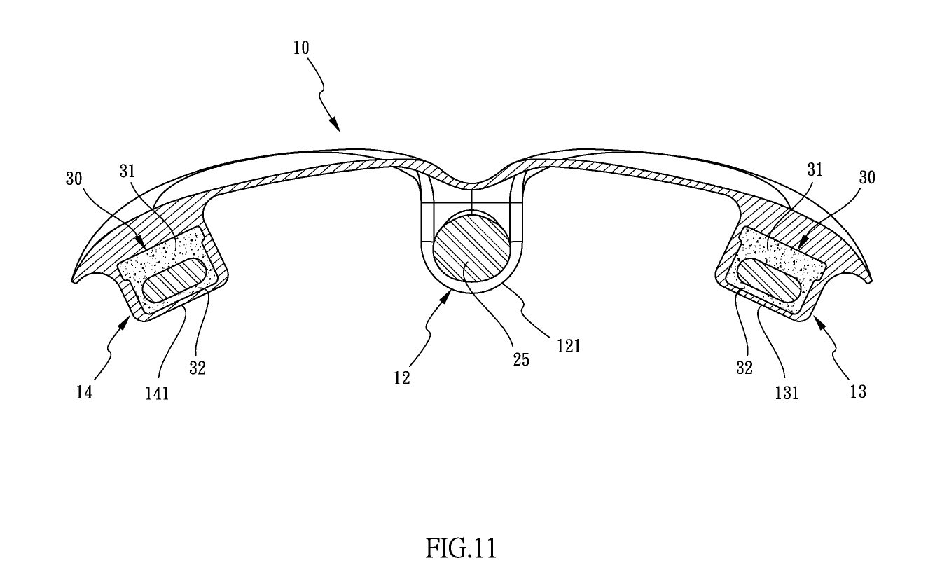

The front support 11 has a curved wall 111 which defines a recess 112. A cover 113 is connected to the curved wall 111 and covers the recess 112. The front part 21 of the rail part 20 is glued to the recess 112 and the cover 113 so as to be connected to the front part 21 to the front support 11. The rear part 25 is glued to the rear support 12. The distal end of the left support bar 26 is mounted with a resilient member 30, and both are inserted in the left support 13. The distal end of the right support bar 27 is mounted with another resilient member 30, and both are inserted in the right support 14. The rear support 12 has a protrusion 121 which has a dent 122 defined in the front end thereof. The rear part 25 of the rail part 20 is glued to the dent 122, wherein the dent 122 and the rear part 25 each have a stepped structure. Each of the left support 13 and the right support 14 has a protrusion 131/141. Each of the two respective protrusion 131, 141 of the left support 13 and the right support 14 has a passage 132/142. As shown in FIG. 11, each of the left support bar 26 and the right support bar 27 has a rectangular cross section. Each of the resilient members 30 is a rectangular member which is mounted to left/right support bar 26/27 and filled with the passage 132. It is noted that the thickness of the top of each of the resilient members 30 is thicker than that of the bottom of each of the resilient members 30. The top 31 resiliently supports the weight and pressure from the seat 10.

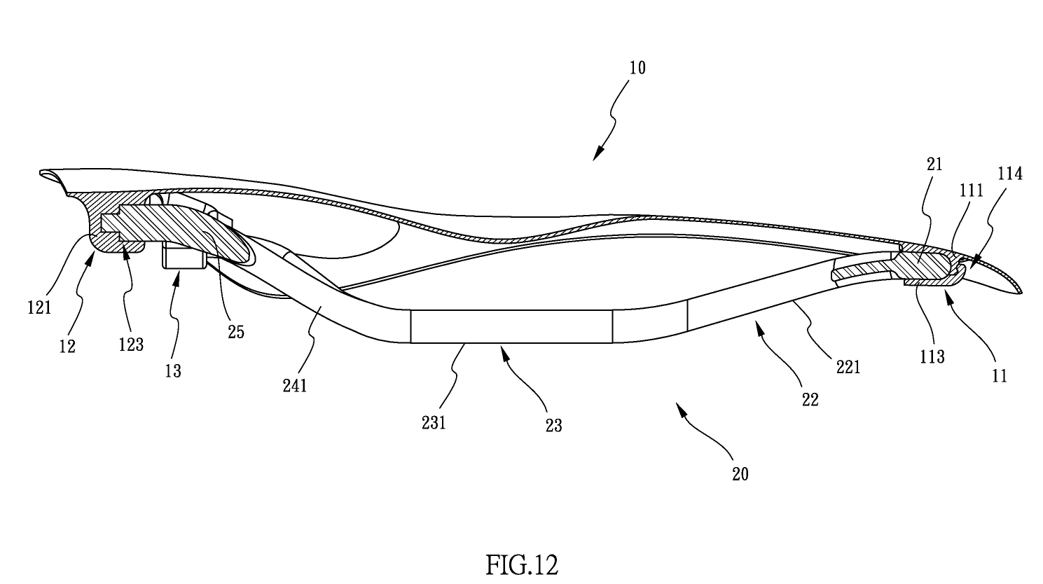

As shown in FIG. 12, the front part 21 is fixed to the front support 11, and the rear part 25 is fixed to the rear support 12, and the split rails 221, the parallel bars 231 and the merging bars 241 form the bow-shaped structure to provide the strength of the seat 10. The outside of the curved wall 111 and the inside of the cover 113 include a protrusion-recess engagement 114 to ensure the connection between the curved wall 111 and the inside of the cover 113. The dent 122 and the rear part 25 each have a stepped structure 123 which provides a larger contact area.

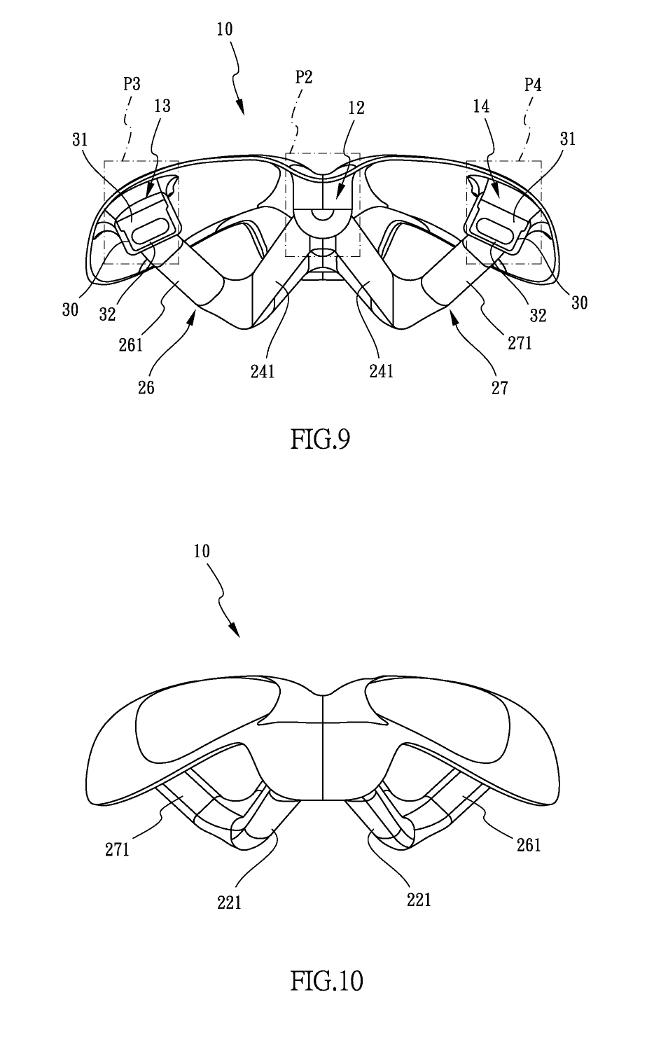

The advantages of the seat assembly of the present invention are that the front part 21, the fork portion 22, the extension portion 23, the rear merging portion 24 and the rear part 25 are all located along the axis L1 of the seat 10, and left support bar 26 and the right support bar 27 respectively extend toward left and right relative to the axis L1 so that the seat is well supported by the four support points P1, P2, P3 and P4 at the underside of the seat, and the four support points P1, P2, P3 and P4 are connected to each other. The merging bars 241, the left support bar 26 and the right support bar 27 are arranged to form a W-shaped structure (FIGS. 9 and 10) to support the user's weight in a larger area. Therefore, the weight of the user is properly shared and the seat is not broken due to stress concentration.

There are three supports located at the rear section of the seat 10 and the pressure applied to the user's bottom is reduced and shared. The resilient members 30 also perform a better buffering and shock-absorbing features.

While we have shown and described the embodiment in accordance with the present invention, it should be clear to those skilled in the art that further embodiments may be made without departing from the scope of the present invention.

What is claimed is:

1. A bicycle seat assembly comprising:
a seat having a front support, rear support, a left support, a right support respectively located at an underside thereof, the front support located at a front end and along an axis of the seat, the rear support located at a rear end and along the axis of the seat, the left support and the right support respectively located at the rear end of the seat, the axis of the seat located between the left support and the right support;
a rail part having a front part, a fork portion connected to the front part, an extension portion connected to the fork portion, a rear merging portion connected to the extension portion, and a rear part connected to the rear merging portion, the front part, the fork portion, the extension portion, the rear merging portion and the rear part all being located along the axis of the seat, the rail part having a left support bar and a right support bar respectively extending toward left and right relative to the axis from an abutment portion of the extension portion and the rear merging portion, and
the front part being glued to the front support, the rear part being glued to the rear support, a distal end of the left support bar being mounted with a resilient member, and both being inserted in the left support, a distal end of the right support bar being mounted with another resilient member, and both being inserted in the right support.

2. The bicycle seat assembly as claimed in claim 1, wherein each of the left and right support bars comprises a front section and a rear section, the front section of each of the left and right support bars extends away from the axis and from the abutment portion of the extension portion and the rear merging portion, the rear section of each of the left and right support bars is parallel to the axis and located close to the left support and right support.

3. The bicycle seat assembly as claimed in claim 1, wherein the fork portion has two split rails which split from the front part and are not parallel to the axis, the extension portion has two parallel bars which are parallel to the axis and respectively extend from the two split rails, the rear merging portion has two merging bars which respectively extend from the two parallel bars, two respective distal ends of the two merging bars are merged into the rear part.

4. The bicycle seat assembly as claimed in claim 3, wherein the two split rails, the two parallel bars and the two merging bars form a bow-shaped arrangement.

5. The bicycle seat assembly as claimed in claim 1, wherein the front support has a curved wall which defines a recess, a cover is connected to the curved wall and covers the recess.

6. The bicycle seat assembly as claimed in claim 5, wherein the front part of the rail part is glued to the recess and the cover so as to be connected to the front part to the front support.

7. The bicycle seat assembly as claimed in claim 1, wherein the rear support has a protrusion which has a dent defined in a front end thereof, the rear part of the rail part is glued to the dent.

8. The bicycle seat assembly as claimed in claim 7, wherein the dent and the rear part each have a stepped structure.

9. The bicycle seat assembly as claimed in claim 1, wherein each of the left support and the right support has a protrusion, each of the two respective protrusion of the left support and the right support has a passage.

10. The bicycle seat assembly as claimed in claim 9, wherein each of the left support bar and the right support bar has a rectangular cross section, each of the resilient members is a rectangular member which is mounted to left/right support bar and filled with the passage, a thickness of a top of each of the resilient members is thicker than that of a bottom of each of the resilient members.
